(19) United States
(12) Patent Application Publication
(10) Pub. No.: US 2008/0264766 A1
(43) Pub. Date: Oct. 30, 2008

(54) Device for Monitoring a Protective Device State

(76) Inventors: Bernd Hermann, Tubingen (DE); Erik Bachle, Filderstadt (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/629,168

(22) PCT Filed: Aug. 1, 2005
(86) PCT No.: PCT/EP2005/008303

§ 371 Date: Dec. 11, 2006

(30) Foreign Application Priority Data
Aug. 7, 2004 (DE) 10 2004 038 488.6
Sep. 27, 2004 (DE) 10 2004 047 574.1

(51) Int. Cl. H01H 9/28

(52) U.S. Cl. 200/43.11

(57) ABSTRACT

The invention relates to a device (1) for monitoring the state of a protective device (2), wherein said protective device (2) comprises a first element (4) provided with an opening (5) and a second element 6) which is movable with respect to the first element (4) in such a way that the opening (5) is closable at least partially, the device (1) comprises a locking device provided with a locking element (18) by which the close state of the protective device (2) is removably lockable and is blocked in the currentless state of the locking device, said locking device is activable by the movement of the protective device (2) from the open to the close state thereof. Said invention is characterised in that the device (1) comprises a blocking device (40) provided with a b locking element (41) and said blocking element (41) prevents in the currentless state the activation of the locking device by blocking the blocking the movement of the locking element (18), thereby leading to the closed state of the protective device (2).

The invention relates to a device for monitoring a protective device state, for example the protective device of a machine, especially a safety switch for monitoring the closed state of a protective door or the like, with a locking function for the protective device.

DE 43 28 297 C1 discloses a safety switch, into the switch head of which an actuator is inserted which is fixed for example on the protective door of a protective device when the protective door is closed, and in doing so turns a ratchet wheel. Within the switch housing the operating plunger of an electric switch is kept in contact with the peripheral surface of the ratchet wheel. At a definable angle of rotation which corresponds to the closed position of the protective door, the operating plunger locks in the catch depression designed for this purpose on the peripheral surface of the ratchet wheel and in the process closes a contact pair in the electric switch. In this way, the inserted state of the actuator and accordingly the closed position of the protective door can be signaled electrically.

For many applications, for example for protective hoods on machine tools or the like, it is necessary for the safety switch to moreover make available a locking function, i.e., that the actuator can be locked in the switch head, especially can be locked with respect to drawing out from the switch head, and thus the protective device can be locked in the closed state. In the known safety switch, for this purpose the operating plunger is kept spring-loaded or magnetically-loaded in the catch depression of the ratchet wheel, in this way the ratchet wheel is locked relative to rotary motion and thus the actuator is locked in the switch head.

For some applications, for example for reasons of fire protection, it is necessary, such as when the electrical voltage supply of the machinery is being turned off in case of a fault, for the protective device to be locked in the closed state, for example in the closed position of a protective door or the like. This engenders the problem that for an otherwise de-energized state of the device, for example on the occasion of cleaning work on the weekend, for unintentional or inadvertent closing of the protective device the locking means is activated and thus the protective device is locked in a then unwanted closed state. The requirement for “Locking in the de-energized state” and simultaneous “Prevention of activation of locking in the de-energized state” consequently constitutes an apparently insurmountable contradiction for generic devices.

DE 34 30 090 A1 shows a safety switch in which in the switch housing for actuating the switch a plunger which can be moved lengthwise is guided and to which a mechanical interlock is assigned which can be released by means of a key which can be inserted into the switch housing. For additional safety, to fix the plunger there is moreover a locking pin which can be moved electromechanically by an electric release signal into its release position.

DE 84 14 199 U1 shows a locking and protective device for a door in which in a power failure the door lock cannot be locked and furthermore the door lock cannot be unlocked in a power failure in the locked state.

DE 202 18 714 U1 shows an emergency unlocking device for safety locking devices on doors, especially on doors of housings for machine tools, which consists of a remote unlocking device which can be actuated at any time and from any location, for example of an electrical emergency switch with a power supply which is independent of the machine control and its power supply.

The object of the invention is to make available a generic device which overcomes the disadvantages of the prior art. In particular, a device with a locking means is to be made available which implements both the function “Locking in the de-energized state” and also the function “Prevention of activation of locking in the de-energized state”. Moreover exact locking is to be permanently and reliably ensured and at the same time large locking forces are to be made available with structurally simple means in an economical and durable manner. Production, installation and maintenance of the device is to be simplified and therefore economical of time and money.

This object is achieved by the device defined in claim 1. Special embodiments of the invention are defined in the dependent claims.

As claimed in the invention, in a device for monitoring the state of a protective device, for example a protective device of a machine, especially a safety switch for monitoring the closed state of a protective door or the like, the protective device having a first part with an opening and a second part which can be moved relative to the first part and thus an opening can be at least partially closed, and the device having a switch element which can be mounted preferably on the first part of the protective device, and an actuator which can be mounted preferably on the second part of the protective device, and which in the closed state of the protective device causes actuation of the switch element and thus the closed state of the protective device can be signaled and monitored, and the device has a locking means with a locking element by which the closed state of the protective device can be releasably locked and is locked in the de-energized state of the locking means, and the locking means can be activated by transferring the protective device out of the open state into the closed state, the object is achieved as claimed in the invention in that the device has a blocking means with a blocking element, and that in the de-energized state the blocking element prevents activation of the locking means by blocking the motion of the locking element of the locking means which leads to locking of the closed state of the protective device.

For the interaction of the switch element and actuator, it can be advantageous for many applications to choose a configuration similar to DE 43 28 297 C1, especially because effective manipulation protection of the device is ensured by the positioning of a ratchet wheel, or generally a cam disk, between the actuator and the switch actuation plunger, i.e., the switch element cannot be manipulated with simple tools such that a safe state of the protective device is simulated, although the protective device is not in the closed state, especially the actuator is not inserted into the switch element. Instead of a rotary cam disk by which the actuator can be especially advantageously inserted into the switch element from several directions in space, there can also be another element which makes manipulation of the safety switch by direct actuation of the switch actuation plunger impossible. The locking of the closed state of the protective device corresponds to the known locking function.

In the known devices the locking means is activated by the actuator turning the cam disk when the protective device is being closed until a locking plunger which is at the same time preferably a component of the actual switch actuation plunger or which in any event is located coaxially to it, engages a radial catch depression of the cam disk and fixes it against continued turning and above all against turning back and thus locks the closed state of the protective device and locks the protective device.

While maintaining the function “Locking in the de-energized state”, in the device as claimed in the invention “Activation of the locking device in the de-energized state” is prevented in that by a blocking element of a preferably separate blocking means which can be mounted in modular form on the switch element, the movement of the locking element can be blocked in any event to such an extent that the closed state of the protective device cannot be locked. In this connection preferably also the switch actuation plunger of the electric switch of the switch element is blocked so that actuation of the switch element which would signal the closed state of the protective device is prevented.

In devices with a cam disk, the actuator can be made in the form of a key, especially in the form of mechanical coding by a special geometrical shape, so that only the correspondingly geometrically shaped actuators are able to turn the cam disk.

Due to the blocking of the locking element as claimed in the invention in the de-energized state when the locking means has not been activated, there is free-wheeling for the relative motion between the actuator and switch element. For example, in the device as claimed in the invention with a cam disk it can be freely turned. Thus, for example in the de-energized state the protective device can be completely closed and the actuator can be inserted into the switch head without fear of mechanical damage to the device, for example as a result of the actuator striking the blocked parts of the switch element.

Here it is especially advantageous for blocking to take place by positive locking between the blocking element and the locking element. Positive locking is defined as the interaction which exists simply by the shape and/or guidance of the movement of two elements in contact with one another, and it is especially independent of the active frictional forces between these elements. By blocking based on positive locking, reliable operation is ensured even under difficult ambient conditions.

In one special embodiment of the invention the blocking element engages a recess of the locking element. By preference the blocking element and/or locking element are made essentially pin-shaped and cylindrical, at least in sections. Furthermore, the locking element on its jacket surface preferably has an annular groove which is essentially rectangular in cross section and which the blocking element can engage. The longitudinal axes of the locking element and the blocking element preferably enclose a right angle.

In one special embodiment the blocking element is part of an electromagnet, especially of the armature of the electromagnet of the blocking means. In the energized state the blocking element is kept in position against the action of an energy, storage mechanism located in the blocking means, by which position the motion of the locking element is not blocked. In the de-energized state the blocking element is moved by the action of the energy storage mechanism in the direction to the locking element, and if the protective device is not already in the closed state, engages a recess in the locking element there such that it is in any event blocked to the extent that when the protective device is closed, locking of the closed state does not occur.

Preferably with its end facing away from the locking element, the blocking element actuates a switch by which the position of the blocking element can be signaled. Preferably the switch is a commercial electrical switching element. Alternatively, other switching elements are also possible for this purpose, especially proximity-switching elements, for example optical switching elements such as photoelectric barriers or magnetic switching elements such as Hall sensors or reed switches. The blocking element can be made as a switch actuation plunger for the switch of the blocking means. In particular, the switch can be located coaxially to the blocking element.

In one special embodiment, the locking means has another element which can be turned and/or displaced when the actuator is inserted into the device. This further element or the locking element can engage the recess of the actuator and can be blocked in this position, and thus can lock the closed state of the protective device. Preferably this further element of the locking means is a ratchet wheel or a drum controller, and in the closed state of the protective device the position of this other element can be locked by the locking element.

In one special embodiment of the invention the locking means has a safety mechanism for unwanted closing by which locking can only be activated when the protective device is in the closed position. This prevents a higher-order control means with the locking means activated from incorrectly assuming that the protective device is closed, although in fact this is not the case. The safety mechanism for unwanted closing can be implemented in different ways. In particular, it is also possible to detect the closed state of the protective device by a sensor, for example by a magnetic sensor which signals the closed state independently of the switch element of the device. It is likewise possible to signal by the switch element itself that the protective device has assumed the closed state and thereupon to activate the locking means.

Other advantages, features and details of the invention will become apparent from the dependent claims and the following description in which-one embodiment will be detailed with reference to the drawings. In this connection the features indicated in the claims and in the specification can each be essential for the invention individually or in any combination.

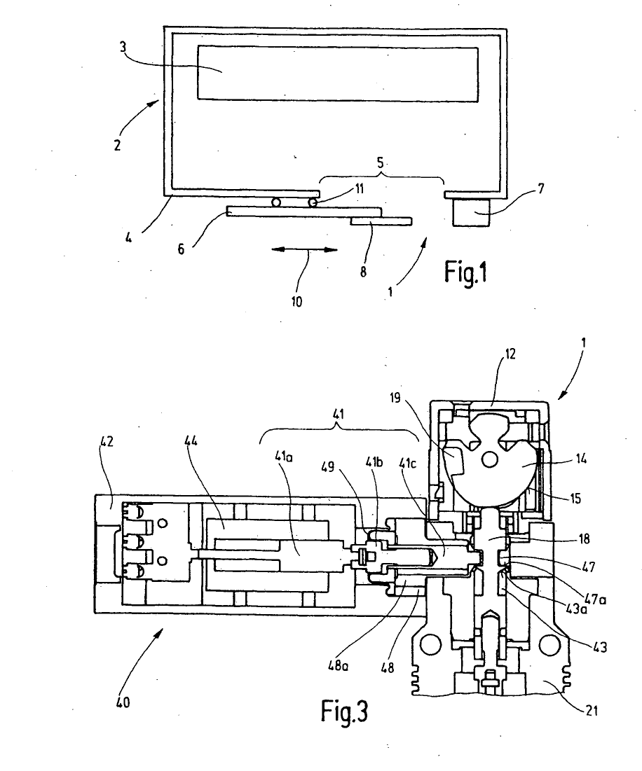

FIG. 1 shows a schematic top view of an overall configuration with a device as claimed in the invention,

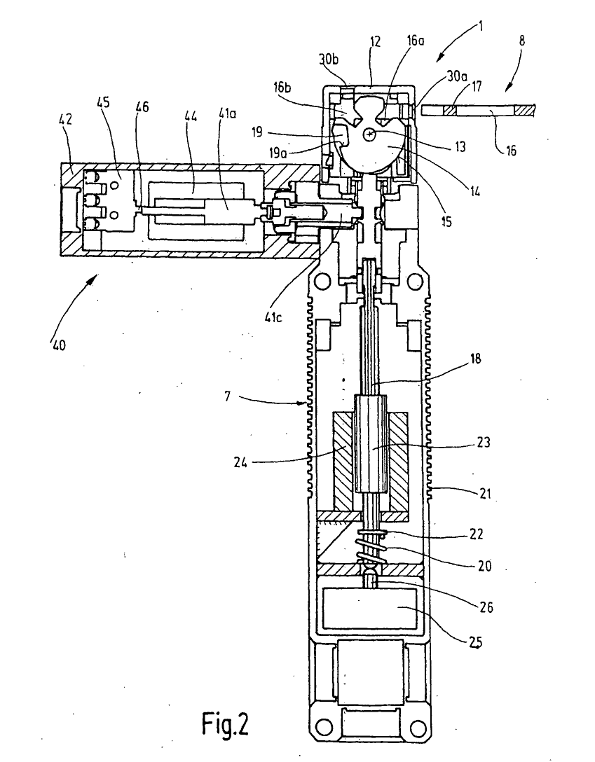

FIG. 2 shows a section through the embodiment of the device as claimed in the invention, and

FIG. 3 shows an enlarged extract of the device of FIG. 2.

FIG. 1 shows a schematic top view of the overall configuration with a device 1 as claimed in the invention for monitoring the state of a protective device 2 of a machine 3, especially of the closed state of a protective door, with which a space separation means can be closed in order for example to protect the operators against danger by a machine 3 which is in operation. The means 2 has a first part 4, for example a frame for the protective device 2. The first part 4 has an opening 5 which can be closed by a second part 6, for example by a protective door, which is movably mounted according to the double arrow 10 relative to the first part 4 by bearing elements 11. The device 1 has a safety switch which comprises a switch element 7 located preferably on the stationary first part 4 of the protective device 2 and an actuator 8 which is located preferably on the movable part 6.

FIG. 2 shows a section through one embodiment of the device 1 as claimed in the invention. In the switch head 12 a cam disk 14 which can be pivoted around the axis 13 of rotation is supported. On its peripheral surface 15 the cam disk 14 has a first recess 16a which can be engaged by a cam 17 of the actuator 8, when the actuator 8 is inserted into the switch head 12 via a first opening 30a. The cam disk 14 with its angle offset of approximately 90° relative to the first recess 16a around the axis 13 of rotation has a second recess 16b which the cam 17 of the actuator 8 can engage when the actuator 8 is inserted into the switch head 12 via a second opening 30b. The segments of the cam disk 14 bordered by the two recesses 16a, 16b with the actuator 8 inserted engage the recess 16 adjoining the cam 17 and thus lock the closed state of the protective device 2. The outside surfaces of the essentially cuboidal and especially cubic switch head 12 on which the first and second opening 30a, 30b are located include a right angle. In the illustrated state the actuator 8 has not yet been inserted into the switch head 12, accordingly the second part 6 of the protective device 2 is not yet in the completely closed position.

The switch head 12 is securely joined to the switch element 7 of the device 1. In the switch element 7 an elongated locking element 18 is mounted to be able to move lengthwise and in the illustrated embodiment has several elements, but essentially can also be made in one piece. The locking element 18 is produced at least in sections from a magnetizable material or has a magnetizable jacket 23 which is made as the armature of an electromagnet which furthermore has a coil 24. When current flows through the coil 24 the jacket 23 is pulled into the region of the coil 24 and in the process the locking element 18 is moved away from the cam disk 14 against the action of an energy storage mechanism 20 which is made as a helical spring. In this way the ratchet wheel 14 is released for movement, especially for guiding the actuator 8 out of the switch head 12 and consequently for opening of the protective means 2 by pushing back the second part 6.

The cam disk 14 with an angle offset of approximately 135° relative to the first recess 16a around the axis 13 of rotation has a third recess 19 which can engage the locking element 18 in the closed state of the protective device 2, i.e., when the actuator 8 has been inserted into the switch head 12, and in this way locks the closed state. The energy storage device 20 is supported on the one hand on the stationary switch housing 21, and on the other on a flange-like widening 22 of the locking element 18. Proceeding from the locked, closed state of the protective device 2 the locking element 18 with respect to pulling out the actuator 8 has positive locking with a locking flank 19aformed by the third recess 19, so that the locking force acting on the second part 6 of the protective device 2 is not limited by the force applied by the energy storage device 20.

In a preferably sealed region of the switch housing 21 the switch element 7 has a conventional electric switch 25 with a switch actuation plunger 26 configured and aligned coaxially and especially in an extension of the locking element 18. By means of an energy storage mechanism which is located in the electric switch 25 and which is not shown, the switch actuation plunger 26 is in contact with the locking element 18 and thus follows its motion. Both the operating state shown in FIG. 2 can thus be signaled by the electric switch 25, for example by opening an electrical switching contact, as can the state in which the locking element 18 engages the recess 19 of the cam disk 14, accordingly locks the ratchet wheel and thus the closed state of the protective device 2, for example by opening the switching contact.

In the state shown in FIG. 2 the protective device 2 is opened or in any event not in the locked closed state and the device 1 is de-energized. Without the configuration of the device 1 as claimed in the invention with a blocking means 40, the locking element 18, based on the action of the energy storage mechanism 20, would be in contact with the cam disk 14, and when the protective device 2 closes, the actuator 8 would turn the cam disk 14 by approximately 90° counterclockwise, and the locking element 18 would lock in the third recess 19 and thus lock the cam disk 14 and accordingly the closed state of the protective device 2.

To prevent this, the blocking means 40 is located in the transition area between the switch head 12 and the switch housing 7. A blocking element 41 which is aligned at a right angle to the locking element 16 and which is movably guided in the longitudinal direction in the housing part 42 can releasably lock the locking element 16 in its position which is shown in FIG. 2 and which releases the rotary motion of the cam disk 14. For this purpose, at least one section of the blocking element 41 which is composed of several elements in the embodiment, but can also be made in one piece, and which is essentially cylindrical especially at least in sections, is made of a magnetizable material and forms the armature of an electromagnet which moreover has another coil 44 which is located in the housing part 42.

On its end facing away from the locking element 18, the blocking element 41 has another electrical switch 45 and for this purpose is in contact with the pertinent switch actuation plunger 46. In the illustrated position the blocking element 41 is pretensioned in the direction to the locking element 18, either by an energy storage mechanism such as a helical spring, which acts on the blocking element 41 and the housing part 42, and can be located for example in the area between the armature and the further coil 44, or by a spring which acts on the switch actuation plunger 46 and which is located in the other electric switch 45. When current is supplied to the other coil 44 the blocking element 41 is moved away from the locking element 18 against the action of the energy storage mechanism and thus releases the locking element 18 for motion which locks the cam disk 14.

FIG. 3 shows an enlarged extract of the device from FIG. 2 in the area of the connection of the blocking means 40 and the switch head 12 as well as the switch housing 21. The blocking element 41 which is formed overall from three elements consists of an armature element 41a, which by means of an end section made essentially T-shaped in cross section, engages an opening of the driver element 41b which has an undercut, which element 41b is dynamically coupled to the armature element 41a. The driver element 41b is in turn dynamically coupled to the blocking element 41c, for example is pressed or screwed to it. Between the driver element 41b and the housing part 42 there is a sealing element 49, for example a bellows-like membrane, in order to prevent penetration of moisture and/or impurities.

The blocking element 41c on its end facing the blocking element 18 has a tapered cylindrical pin which in the illustrated position positively engages the annular groove 47 which is made in the locking element 18 and which is essentially rectangular in cross section. The blocking element 41c is guided in a guide sleeve 48 which is preferably essentially axially-symmetrical and especially rotationally symmetrical, except for an eccentric axial hole 48a, and which moreover closes the housing part 42 on the end face. The position of the blocking flank 47a which is formed by the annular groove 47a and which includes with the longitudinal axis of the locking element 18 an essentially right angle is selected such that when the blocking element 41c is not in blocking engagement, the locking element 18 does not adjoin the peripheral surface 15 of the cam disk 14, but has a short distance from it.

On the side facing away from the cam disk 14, the locking element 18 has another annular groove 43 which can be of greater axial extension. The blocking element 41c engages this other annular groove 43 when, in the closed state of the protective device 2, the locking element 18 engages the third recess 19 of the ratchet wheel 14, and the other coil 44 is operated de-energized. The blocking element 41 in this case is limited by a mechanical stop in its movement in the direction to the locking element 18 such that the front end of the blocking element 41c is not in contact with the bottom surface of the other annular groove 43 extending parallel to the longitudinal axis of the locking element 18. In this way friction between the blocking element 41c and the locking element 18 is prevented when the locking element 18 is moved out of the third recess 19 by energizing the coil 24 in order to unlock the locked state of the protective device 2.

The other annular groove 43 on its side facing the annular groove 47 has a sliding flank 43a which with the longitudinal axis of the locking element 18 has an angle of less than 90°, especially less than 60°, and preferably less than 45°. In this way, when the coil 24 is energized and for the resulting movement of the locking element 18 the blocking element 41c can be pushed back by means of the sliding flank 43a and can emerge from the other annular groove 43, in order to then lock in the annular groove 47 and block the locking element 18 in its position shown in FIGS. 2 and 3.

For a configuration of the switch housing 21 and/or the switch head 12 which is axially symmetrical at least in sections, in the area of the connection to the blocking means 40 it can be fixed projecting in several directions in space, by which installation of the device on the protective device 2 is simplified, and the device 1 even at the installation site can be adapted to the respective structural circumstances; in the case of a rotationally-symmetrical configuration, in this connecting area the blocking means 40 can even be configured to rotate around, then if necessary suitable measures for sealing the connecting site must be taken.

1. Device (1) for monitoring a protective device (2) state, especially a safety switch for monitoring the closed state of a protective door or the like, the protective device (2) having a first part (4) with an opening (5) and a second part (6) which can be moved relative to the first part (4) and thus the opening (5) can be at least partially closed, and
the device (1) having a switch element (7) which can be placed preferably on the first part (4) of the protective device (2) and an actuator (8) which can be configured preferably on the second part (6) of the protective device (2), and which in the closed state of the protective device (2) causes actuation of the switch element (7) and thus the closed state of the protective device (2) can be signaled and monitored,
and the device (1) having a locking means with a locking element (18) by which the closed state of the protective device (2) can be releasably locked and is locked in the de-energized state of the locking means, and the locking means can be activated by transferring the protective device (2) out of the open state into the closed state,
characterized in that
the device (1) has a blocking means (40) with a blocking element (41),
and that in the de-energized state the blocking element (41) prevents activation of the locking means by blocking the motion of the locking element (18) of the locking means which leads to locking of the closed state of the protective device (2).

2. The device (1) as claimed in claim 1, wherein in the de-energized state when the locking means has not been activated, there is free-wheeling for the relative motion between the actuator (8) and switch element (7).

3. The device (1) as claimed in claim 1, wherein the blocking element (41) is in positive contact with the locking element (18) during blocking.

4. The device (1) as claimed in claim 1, wherein the locking element (18) on its outside surface has a recess, for example an annular groove (47) which the blocking element (41) engages during blocking.

5. The device (1) as claimed in claim 1, wherein the blocking element (41) can be moved obliquely and especially transversely to the locking element (18).

6. The device (1) as claimed in claim 1, wherein the blocking element (41) is part of an electromagnet of the blocking means (40), by means of which in the energized state the blocking element (41) can be kept in the position which does not block the motion of the locking element (18) against the action of an energy storage mechanism.

7. The device (1) as claimed in claim 1, wherein the blocking element (41) actuates a switch (45) by means of which the position of the blocking element (41) can be signaled, the switch (45) being located preferably coaxially to the blocking element (41).

8. The device (1) as claimed in claim 1, wherein in the closed state of the protective device (2) an element of the locking means engages the recess (16) of the actuator (8) and thus locks the closed state of the protective device (2).

9. The device (1) as claimed in claim 1, wherein the locking means has a cam disk (14) which is pivotally mounted in the switch element (7), which can be turned by the actuator (8) and which locks the actuator (8) in the closed state of the protective device (2), and wherein the rotary motion of the cam disk (14) can be locked by the locking element (41).

10. The device (1) as claimed in claim 1, wherein the locking means has a safety mechanism for unwanted closing by which locking can only be activated when the protective device (2) is in the closed state.
